(19) United States
(12) Patent Application Publication
(10) Pub. No.: US 2023/0294734 A1
(43) Pub. Date: Sep. 21, 2023

(54) METHOD AND DEVICE FOR GENERATING A PATH OF AN AUTONOMOUS VEHICLE

(71) Applicants: HYUNDAI MOTOR COMPANY, Seoul (KR); KIA CORPORATION, Seoul (KR)

(72) Inventor: Yeong Ho Lee, Pohang-si (KR)

(73) Assignees: HYUNDAI MOTOR COMPANY, Seoul (KR); KIA CORPORATION, Seoul (KR)

(21) Appl. No.: 18/071,214

(22) Filed: Nov. 29, 2022

(30) Foreign Application Priority Data
Mar. 16, 2022 (KR) 10-2022-0032572

(51) Int. Cl. B60W 60/00

(52) U.S. Cl. CPC B60W 60/0015; B60W 2520/06; B60W 2552/05; B60W 2556/45

(57) ABSTRACT

A method for generating a path of an autonomous vehicle includes operating, by a controller, a driving source to control the autonomous vehicle to follow a node line of a parking lot and enter a turning section; setting, by the controller, a turning start point of the autonomous vehicle, a turning start direction of the autonomous vehicle, a turning end point of the autonomous vehicle, and a turning end direction of the autonomous vehicle using a parking lot map that is provided from a server that manages the parking lot; generating, by the controller, a first shortest turning path of the autonomous vehicle using a shortest turning path generating method that uses the turning start point , the turning start direction, the turning end point, and the turning end direction; and operating, by the controller, a driving source to drive the autonomous vehicle along the first shortest turning path.

### CROSS-REFERENCE TO RELATED APPLICATION

This application claims priority to and the benefit of Korean Patent Application No. 10-2022-0032572 filed in the Korean Intellectual Property Office on Mar. 16, 2022, the entire contents of which are incorporated herein by reference.

### BACKGROUND OF THE DISCLOSURE

### (a) Technical Field

The present disclosure relates to a vehicle, and more particularly, to a method and a device for generating a path of an autonomous vehicle.

### (b) Description of the Related Art

An autonomous driving vehicle refers to a vehicle that autonomously drives to a given destination by identifying a surrounding environment without driver intervention, judging a driving situation, and controlling the vehicle.

In order to realize one or more functions of the autonomous driving vehicle, the autonomous driving vehicle is equipped with a camera, an infrared sensor, a radar, a global positioning system (GPS), a lidar system, or a gyroscope. Further, autonomous parking technology that autonomously performs parking not only on a road but also in a parking lot is being developed using the functions of the vehicle.

The above information disclosed in this Background section is provided only to enhance understanding of the background of the disclosure. Therefore, the Background section may contain information that does not form the prior art that is already known in this country to a person of ordinary skill in the art.

### SUMMARY OF THE DISCLOSURE

The present disclosure provides a method and a device for generating a path of an autonomous vehicle. Specifically, the method and device are capable of generating an optimal path for the autonomous vehicle to travel in or through a turning section (or a rotation section) in a parking lot.

An embodiment of the present disclosure may provide a method for generating a path of an autonomous vehicle. The method may include: operating, by a controller, a driving source to control the autonomous vehicle so that the autonomous vehicle follows a node line of a parking lot and enters a turning section. The method may also include setting, by the controller, a turning start point of the autonomous vehicle, a turning start direction of the autonomous vehicle, a turning end point of the autonomous vehicle, and a turning end direction of the autonomous vehicle using a parking lot map that is provided from a server that manages the parking lot. The method may further include generating, by the controller, a first shortest turning path of the autonomous vehicle using a shortest turning path generating method that uses the turning start point of the autonomous vehicle, the turning start direction of the autonomous vehicle, the turning end point of the autonomous vehicle, and the turning end direction of the autonomous vehicle as input information. The method may also include operating, by the controller, a driving source to drive the autonomous vehicle along the first shortest turning path.

A method for generating the first shortest turning path may include a Dubins path generation method that generates the first shortest turning path. The first shortest turning path may be generated using the turning start point of the autonomous vehicle, the turning start direction of the autonomous vehicle, a circle that has a turning radius at the turning start point of the autonomous vehicle and that prevents a rear end of the autonomous vehicle from hitting a first obstacle, the turning end point of the autonomous vehicle, the turning end direction of the autonomous vehicle, and a circle that has a turning radius of less than or equal to a maximum turning radius of the autonomous vehicle at the turning end point of the autonomous vehicle.

The method for generating the path of the autonomous vehicle may further include determining, by the controller, whether the autonomous vehicle would contact a second obstacle positioned in the turning section if the autonomous vehicle travels along the first shortest turning path. The method may also include operating, by the controller, the driving source to move the autonomous vehicle backward by a reference distance value when the autonomous vehicle would contact the second obstacle. The method may further include using, by the controller, the parking lot map to reset a position where the autonomous vehicle moves backward to a turning start point of the autonomous vehicle and resetting, by the controller, a turning start direction of the autonomous vehicle at the position where the autonomous vehicle moves backward and a turning end direction of the autonomous vehicle using the parking lot map. The method may also include generating, by the controller, a second shortest turning path of the autonomous vehicle using a shortest turning path generating method that uses the reset turning start point of the autonomous vehicle, the reset turning start direction of the autonomous vehicle, the set turning end point of the autonomous vehicle, and the reset turning end direction of the autonomous vehicle as input information. The method may also include operating, by the controller, the driving source to drive the autonomous vehicle along the second shortest turning path.

A method for generating the second shortest turning path may include a Dubins path generation method that generates the second shortest turning path. The second shortest turning path may be generated using the reset turning start point of the autonomous vehicle, the reset turning start direction of the autonomous vehicle, a circle that has a turning radius at the reset turning start point of the autonomous vehicle and prevents a rear end of the autonomous vehicle from hitting the second obstacle, the set turning end point of the autonomous vehicle, the reset turning end direction of the autonomous vehicle, and a circle that has a turning radius of less than or equal to a maximum turning radius of the autonomous vehicle at the set turning end point of the autonomous vehicle.

An embodiment of the present disclosure may provide a device for generating a path of the autonomous vehicle. The device may include a data detector configured to detect that the autonomous vehicle would contact a first obstacle positioned in a turning section of a parking lot and a controller configured to operate a driving source to control the autonomous vehicle so that the autonomous vehicle follows a node line of the parking lot and enters the turning section. The controller may be configured to set a turning start point of the autonomous vehicle, a turning start direction of the autonomous vehicle, a turning end point of the autonomous vehicle, and a turning end direction of the autonomous vehicle using a parking lot map that is provided from a server managing the parking lot. The controller may be configured to generate a first shortest turning path of the autonomous vehicle using a shortest turning path generating method that uses the turning start point of the autonomous vehicle, the turning start direction of the autonomous vehicle, the turning end point of the autonomous vehicle, and the turning end direction of the autonomous vehicle as input information. The controller may be configured to operate the driving source to drive the autonomous vehicle along the first shortest turning path.

A method for generating the first shortest turning path may include a Dubins path generation method that generates the first shortest turning path. The first shortest turning path may be generated using the turning start point of the autonomous vehicle, the turning start direction of the autonomous vehicle, a circle that has a turning radius at the turning start point of the autonomous vehicle and prevents a rear end of the autonomous vehicle from hitting a second obstacle, the turning end point of the autonomous vehicle, the turning end direction of the autonomous vehicle, and a circle that has a turning radius of less than or equal to a maximum turning radius of the autonomous vehicle at the turning end point of the autonomous vehicle.

The controller may be configured to determine whether the autonomous vehicle would contact the first obstacle positioned in the turning section if the autonomous vehicle travels along the first shortest turning path. The controller may be configured to operate the driving source to move the autonomous vehicle backward by a reference distance value when the autonomous vehicle would contact the first obstacle. The controller may be configured to use the parking lot map to reset a position where the autonomous vehicle moves backward to a turning start point of the autonomous vehicle. The controller may be configured to reset a turning start direction of the autonomous vehicle at the position where the autonomous vehicle moves backward and a turning end direction of the autonomous vehicle using the parking lot map. The controller may be configured to generate a second shortest turning path of the autonomous vehicle using a shortest turning path generating method that uses the reset turning start point of the autonomous vehicle, the reset turning start direction of the autonomous vehicle, the set turning end point of the autonomous vehicle, and the reset turning end direction of the autonomous vehicle as input information. The controller may be configured to operate the driving source to drive the autonomous vehicle along the second shortest turning path.

A method for generating the second shortest turning path may include a Dubins path generation method that generates the second shortest turning path. The second shortest turning path may be generated using the reset turning start point of the autonomous vehicle, the reset turning start direction of the autonomous vehicle, a circle that has a turning radius at the reset turning start point of the autonomous vehicle and prevents a rear end of the autonomous vehicle from hitting the first obstacle, the set turning end point of the autonomous vehicle, the reset turning end direction of the autonomous vehicle, and a circle that has a turning radius less than or equal to a maximum turning radius of the autonomous vehicle at the set turning end point of the autonomous vehicle.

The method and the device for generating a path of the autonomous vehicle according to the embodiment of the present disclosure may generate a shortest path for the vehicle to travel in the turning section in the parking lot using the shortest turning path generating method (e. g., the Dubins path generating method) having or requiring a small amount of computation. Therefore, embodiments of the present disclosure may control the vehicle to travel in the turning section of the parking lot by following the node line of the parking lot.

### BRIEF DESCRIPTION OF THE DRAWINGS

A brief description of the drawings is provided below. The above and other objectives, features, and advantages of the present disclosure should be more clearly understood from the drawings which are described in the detailed description of the present disclosure.

FIG. 1 is a flowchart illustrating a method for generating a path of an autonomous vehicle according to an embodiment of the present disclosure.

FIG. 2 is a block diagram explaining a device for generating a path of an autonomous vehicle to which the method for generating the path of the autonomous vehicle shown in FIG. 1 is applied.

FIG. 3 is a view explaining a step of generating a first shortest turning path shown in FIG. 1.

FIG. 4 is a view explaining a step of generating a second shortest turning path shown in FIG. 1.

### DETAILED DESCRIPTION OF THE EMBODIMENTS

In order to fully describe the present disclosure and the objects achieved by embodiments of the present disclosure, the accompanying drawings illustrating embodiments of the present disclosure are described below for reference.

Hereinafter, the present disclosure is described in detail by describing embodiments of the present disclosure with reference to the accompanying drawings. In describing the embodiments of the present disclosure, well-known configurations or functions have not been described in detail because a description thereof may unnecessarily obscure the gist of the present disclosure. Throughout the accompanying drawings, the same reference numerals are used to denote the same components.

Terms used in the present specification are only used in order to describe specific embodiments rather than limiting the present disclosure. Singular forms are to include plural forms unless the context clearly indicates otherwise. It should be further understood that the terms “comprise,” “include,” or “have,” used in the present specification specify the presence of features, numerals, steps, operations, components, or parts mentioned in the present specification, or a combination thereof, but do not preclude the presence or addition of one or more other features, numerals, steps, operations, components, parts, or a combination thereof.

Throughout this specification and the claims that follow, when it is described that an element is “coupled” to another element, the element may be “directly coupled” to the other element or “electrically or mechanically coupled” to the other element through a third element.

Unless defined otherwise, it is to be understood that the terms used in the present specification including technical and scientific terms have the same meanings as those that are generally understood by those of ordinary skill in the art. It should be understood that terms defined by the dictionary have meanings consistent with the meanings within the context of the related art, and should not be ideally or excessively formally defined unless the context clearly dictates otherwise. When a component, device, element, or the like of the present disclosure is described as having a purpose or performing an operation, function, or the like, the component, device, or element should be considered herein as being “configured to” meet that purpose or perform that operation or function.

A movement path (or a node line) of an autonomous vehicle is provided by a server installed in a parking lot. The movement path is created based on a parking lot map including parking area information of the parking lot and a parking line of the parking lot. The autonomous vehicle searches for a space (or a parking space) and then moves along the movement path of the parking lot to park in a designated position.

Unlike a general road, the following problem occurs when an autonomous vehicle drives along the path of the parking lot. Many vehicles block a detection area of the autonomous vehicle's camera (or a light detection and ranging (LIDAR) system) in the parking lot so that the detection area of the vehicle has many shaded areas in which objects cannot be detected when the vehicle is traveling. Therefore, when the autonomous vehicle travels along the node line of the parking lot, the vehicle may encounter an obstacle (e.g., an obstacle positioned on a road of the parking lot) in the turning section of the parking lot. If the autonomous vehicle does not appropriately respond to avoid the obstacle in this case, the vehicle may deviate from or not follow the node line. However, if an appropriate turning path (avoidance path) is provided when the autonomous vehicle encounters an obstacle after entering the shaded area, the vehicle may follow the node line.

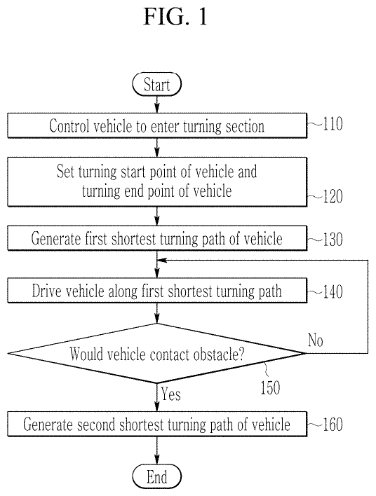

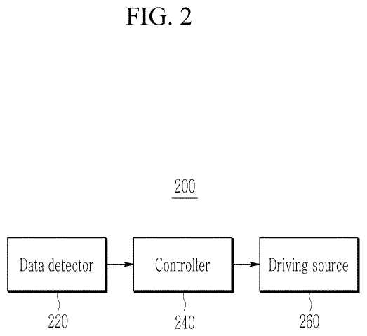

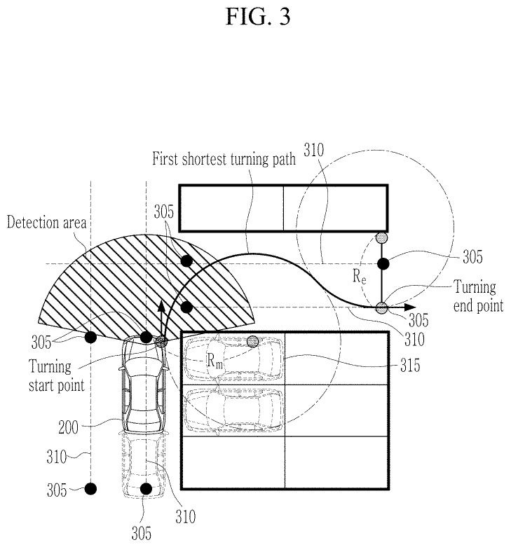

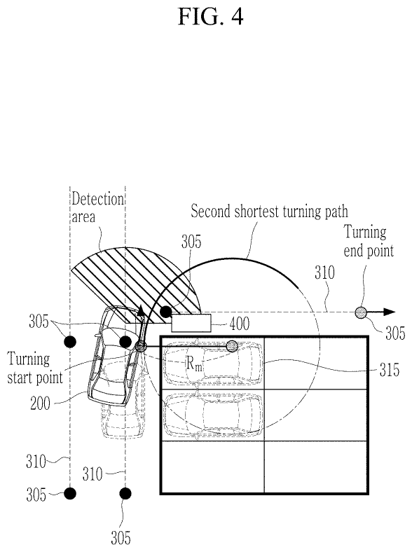

FIG. 1 is a flowchart illustrating a method for generating a path of an autonomous vehicle according to an embodiment of the present disclosure. FIG. 2 is a block diagram illustrating a device for generating a path of an autonomous vehicle to which the method for generating the path of the autonomous vehicle shown in FIG. 1 is applied. FIG. 3 is a view explaining a step of generating a first shortest turning path shown in FIG. 1. FIG. 4 is a view explaining a step of generating a second shortest turning path shown in FIG. 1.

Referring to FIGS. 1-4, in a step 110, as shown in FIG. 3, a controller 240 may operate a driving source 260 to control the autonomous vehicle 200 so that the autonomous vehicle follows a node line 310 of a parking lot and enters a turning section. The node line 310 may be provided by a parking lot management server installed in the parking lot and may mean a path through which the autonomous vehicle 200 moves in the parking lot. The parking lot management server that manages the parking lot may generate the node line through which the autonomous vehicle 200 moves based on a parking lot map including a parking area and a parking line of the parking lot. The node line 310 may mean a line connecting nodes 305, which are points marked at regular intervals in a movement path of the vehicle. A detection area shown in FIGS. 3 and 4 may mean an area in which a camera, a light detection and ranging (LIDAR) system (or a LIDAR sensor), or an ultrasonic wave sensor included in a data detector 220 of the autonomous vehicle 200 detects an obstacle in front of the vehicle.

As shown in FIG. 2, the autonomous vehicle 200 may include the data detector 220, the controller 240, and the driving source (or a power source) 260 such as an engine or an electric motor driving the vehicle. The autonomous vehicle 200 may further include a global positioning system (GPS) receiver for generating position information of the autonomous vehicle. The device for generating the path of the autonomous vehicle may include the data detector 220 and the controller 240.

The controller 240 may be an electronic control unit (ECU) and may control an entire operation of the autonomous vehicle 200. For example, the controller 240 may be one or more microprocessors operated by a program (i.e., a control logic) or hardware (e.g., a microcomputer) including the microprocessor. The program may include a series of commands for executing the method for generating the path of the autonomous vehicle according to an embodiment of the present disclosure. The commands may be stored in a memory of the controller 240. The memory may include one or more read only memory (ROM), random access memory (RAM), a flash memory, an electric erasable program read only memory (EEPROM), or other type of memory.

According to a step 120 shown in FIG. 1, in order to generate an optimal path (or a shortest path) along which the autonomous vehicle 200 travels through the turning section, the controller 240 may set a turning start point of the autonomous vehicle 200, a turning start direction of the autonomous vehicle 200, a turning end point (or a turning arrival point) of the autonomous vehicle 200, and a turning end direction of the autonomous vehicle 200. The turning start point, turning start direction, turning end point, and turning end direction of the autonomous vehicle 200 are all shown in FIGS. 3 and 4. The controller 240 may set the turning start point, turning start direction, turning end point, and turning end direction of the autonomous vehicle 200 using the parking lot map (parking lot map information) that is provided (or received) from the parking lot management server. The parking lot map (parking lot map information) includes the parking line. In another embodiment of the present disclosure, the controller 240 may receive the parking lot map information through a communicator of the autonomous vehicle 200. The communicator may include any operable connection. An operable connection may be one in which signals, physical communications, and/or logical communications may be sent and/or received. The communicator may be connected to the internet and/or other networks.

For example, when the turning section is a left turning section, the turning start point of the autonomous vehicle 200 may be a front left end portion (e.g., an end of a front left bumper, a front left end of a bumper) of the autonomous vehicle. When the turning section is a right turning section, the turning start point of the autonomous vehicle 200 may be a front right end portion (e.g., an end of a front right bumper, a front right end of a bumper) of the autonomous vehicle.

According to a step 130, as shown in FIG. 3, the controller 240 may generate a first shortest turning path of the autonomous vehicle 200 using a shortest turning path generating method (e.g., a Dubins path generation method or a Dubins path generation algorithm) that uses the turning start point of the autonomous vehicle 200, the turning start direction of the autonomous vehicle, the turning end point (or a turning termination point) of the autonomous vehicle, and the turning end direction of the autonomous vehicle as input information. The Dubins path generation method may generate the first shortest turning path that connects two points on a two-dimensional plane, is the shortest path, and is a Dubins path. A Dubins path is a shortest curved line using the turning start point of the autonomous vehicle 200, the turning start direction of the autonomous vehicle 200, a circle that is shown in FIG. 3 having a radius Rm, the turning end point of the autonomous vehicle 200, the turning end direction of the autonomous vehicle 200, and a circle that is shown in FIG. 3 having a radius Re. The circle shown in FIG. 3 having a radius Rm has a turning radius Rm at the turning start point of the autonomous vehicle 299 and prevents a rear end (e.g., an end of a rear right bumper of the autonomous vehicle from hitting an obstacle (e.g., a parked vehicle 315) when the autonomous vehicle turns in consideration of a width of a road in the parking lot. The circle having a radius Re has a turning radius Re of less than or equal to a maximum turning radius of the autonomous vehicle 200 at the turning end point of the autonomous vehicle 200. The shortest path may include a path including of at least two circular paths. For example, the Dubins path generation method for generating the Dubins path may be performed by a known method using input information including the turning start point, the turning start direction, the circle having the turning radius Rm, the turning end point, the turning end direction, and the circle having the turning radius Re.

According to a step 140, the controller 240 may operate the driving source 260 to drive the autonomous vehicle 200 along the first shortest turning path.

According to a step 150, as shown in FIG. 4, the controller 240 may determine whether the autonomous vehicle 200 would contact an obstacle 400 positioned in the turning section if the autonomous vehicle 200 travels along the first shortest turning path. The data detector 220 may detect that the autonomous vehicle 200 would contact the obstacle 400 and may provide the detected information to the controller 240. The determining of whether the autonomous vehicle 200 would contact the obstacle 400 positioned in the turning section may be performed while the autonomous vehicle 200 is travelling along the first shortest turning path, prior to actually contacting the obstacle 400.

The method for generating the path of the autonomous vehicle, which is a process, may proceed to a step 160 when it is determined that the autonomous vehicle 200 would contact the obstacle 400, and the process may proceed to the step 140 when the autonomous vehicle 200 would not contact the obstacle 400.

According to the step 160, the controller 240 may operate the driving source 260 to move the autonomous vehicle 200 backward by a reference distance value. The reference distance value may be a value for the autonomous vehicle 200 to avoid the obstacle 400.

The controller 240 may use the parking lot map to reset a position where the autonomous vehicle 200 moves backward to a turning start point of the autonomous vehicle. Further, the controller 240 may reset a turning start direction of the autonomous vehicle 200 at the position where the autonomous vehicle 200 moves backward and a turning end direction of the autonomous vehicle 200 using the parking lot map.

As shown in FIG. 4, the controller 240 may generate a second shortest turning path of the autonomous vehicle 200 using a shortest turning path generating method (e.g., the Dubins path generation method) that uses the reset turning start point of the autonomous vehicle 200, the reset turning start direction of the autonomous vehicle, the set turning end point of the autonomous vehicle, and the reset turning end direction of the autonomous vehicle as input information. The Dubins path generation method may generate the second shortest turning path that connects two points on a two-dimensional plane, is a shortest path, and is the Dubins path. The Dubins path is the shortest curved line using the reset turning start point of the autonomous vehicle 200, the reset turning start direction of the autonomous vehicle 200, a circle that is shown in FIG. 4 having a radius Rm, the set turning end point of the autonomous vehicle 200, the reset turning end direction of the autonomous vehicle 200, and a circle that has a turning radius Re less than or equal to the maximum turning radius of the autonomous vehicle 200 at the set turning end point of the autonomous vehicle 200. The circle shown in FIG. 4 having a radius Rm has a turning radius Rm at the reset turning start point of the autonomous vehicle 200 and prevents the rear end (e.g., the end of the rear right bumper) of the autonomous vehicle from hitting the obstacle 400 when the autonomous vehicle turns. The shortest path may include a path including of at least two circular paths.

The controller 240 may operate the driving source 260 to drive the autonomous vehicle 200 along the second shortest turning path.

The components, “˜units”, “˜ or”, blocks, or modules used in an embodiment of the present disclosure may be implemented by software such as tasks, classes, sub-routines, processes, objects, execution threads, or programs performed in a predetermined region on a memory or hardware such as a field-programmable gate array (FPGA) or an application-specific integrated circuit (ASIC) and may be implemented by a combination of the software and the hardware. The components, ‘˜ part’, or the like may be embedded in a computer-readable storage medium, and some part thereof may be dispersedly distributed in a plurality of computers.

As set forth above, embodiments of the present disclosure have been illustrated in the accompanying drawings and described in the specification. Herein, specific terms have been used for the purpose of describing the present disclosure. The specific terms used herein are used only for the purpose of describing the present disclosure and should not be interpreted as qualifying the meaning or limiting the scope of the present disclosure, which is disclosed in the appended claims. Therefore, it should be understood by those of ordinary skill in the art that various modifications and equivalent embodiments of the present disclosure are possible based on the present disclosure. Accordingly, the scope of the present disclosure must be construed based on the scope and spirit of the appended claims.

### DESCRIPTION OF SYMBOLS

220: data detector
240: controller

What is claimed is:

1. A method for generating a path of an autonomous vehicle, the method comprising:
operating, by a controller, a driving source to control the autonomous vehicle so that the autonomous vehicle follows a node line of a parking lot and enters a turning section;
setting, by the controller, a turning start point of the autonomous vehicle, a turning start direction of the autonomous vehicle, a turning end point of the autonomous vehicle, and a turning end direction of the autonomous vehicle using a parking lot map that is provided from a server that manages the parking lot;
generating, by the controller, a first shortest turning path of the autonomous vehicle using a shortest turning path generating method that uses the turning start point of the autonomous vehicle, the turning start direction of the autonomous vehicle, the turning end point of the autonomous vehicle, and the turning end direction of the autonomous vehicle as input information; and
operating, by the controller, a driving source to drive the autonomous vehicle along the first shortest turning path.

2. The method of claim 1, wherein a method for generating the first shortest turning path includes a Dubins path generation method that generates the first shortest turning path using the turning start point of the autonomous vehicle, the turning start direction of the autonomous vehicle, a circle that has a turning radius at the turning start point of the autonomous vehicle and prevents a rear end of the autonomous vehicle from hitting a first obstacle, the turning end point of the autonomous vehicle, the turning end direction of the autonomous vehicle, and a circle that has a turning radius of less than or equal to a maximum turning radius of the autonomous vehicle at the turning end point of the autonomous vehicle.

3. The method of claim 1, further comprising:
determining, by the controller, whether the autonomous vehicle would contact a second obstacle positioned in the turning section if the autonomous vehicle travels along the first shortest turning path;
operating, by the controller, the driving source to move the autonomous vehicle backward by a reference distance value when the autonomous vehicle would contact the second obstacle;
using, by the controller, the parking lot map to reset a position where the autonomous vehicle moves backward to a turning start point of the autonomous vehicle;
resetting, by the controller, a turning start direction of the autonomous vehicle at the position where the autonomous vehicle moves backward and a turning end direction of the autonomous vehicle using the parking lot map;
generating, by the controller, a second shortest turning path of the autonomous vehicle using a shortest turning path generating method that uses the reset turning start point of the autonomous vehicle, the reset turning start direction of the autonomous vehicle, the set turning end point of the autonomous vehicle, and the reset turning end direction of the autonomous vehicle as input information; and
operating, by the controller, the driving source to drive the autonomous vehicle along the second shortest turning path.

4. The method of claim 3, wherein a method for generating the second shortest turning path includes a Dubins path generation method that generates the second shortest turning path using the reset turning start point of the autonomous vehicle, the reset turning start direction of the autonomous vehicle, a circle that has a turning radius at the reset turning start point of the autonomous vehicle and prevents a rear end of the autonomous vehicle from hitting the second obstacle, the set turning end point of the autonomous vehicle, the reset turning end direction of the autonomous vehicle, and a circle that has a turning radius of less than or equal to a maximum turning radius of the autonomous vehicle at the set turning end point of the autonomous vehicle.

5. A device for generating a path of an autonomous vehicle, comprising:
a data detector configured to detect that the autonomous vehicle would contact a first obstacle positioned in a turning section of a parking lot; and
a controller configured to operate a driving source to control the autonomous vehicle so that the autonomous vehicle follows a node line of the parking lot and enters the turning section,
wherein the controller is configured to set a turning start point of the autonomous vehicle, a turning start direction of the autonomous vehicle, a turning end point of the autonomous vehicle, and a turning end direction of the autonomous vehicle using a parking lot map that is provided from a server managing the parking lot, and
wherein the controller is configured to generate a first shortest turning path of the autonomous vehicle using a shortest turning path generating method that uses the turning start point of the autonomous vehicle, the turning start direction of the autonomous vehicle, the turning end point of the autonomous vehicle, and the turning end direction of the autonomous vehicle as input information, and
wherein the controller is configured to operate the driving source to drive the autonomous vehicle along the first shortest turning path.

6. The device of claim 5, wherein a method for generating the first shortest turning path includes a Dubins path generation method that generates the first shortest turning path using the turning start point of the autonomous vehicle, the turning start direction of the autonomous vehicle, a circle that has a turning radius at the turning start point of the autonomous vehicle and prevents a rear end of the autonomous vehicle from hitting a second obstacle, the turning end point of the autonomous vehicle, the turning end direction of the autonomous vehicle, and a circle that has a turning radius of less than or equal to a maximum turning radius of the autonomous vehicle at the turning end point of the autonomous vehicle.

7. The device of claim 5, wherein the controller is configured to determine whether the autonomous vehicle would contact the first obstacle positioned in the turning section if the autonomous vehicle travels along the first shortest turning path,
wherein the controller is configured to operate the driving source to move the autonomous vehicle backward by a reference distance value when the autonomous vehicle would contact the first obstacle,
wherein the controller is configured to use the parking lot map to reset a position where the autonomous vehicle moves backward to a turning start point of the autonomous vehicle,
wherein the controller is configured to reset a turning start direction of the autonomous vehicle at the position where the autonomous vehicle moves backward and a turning end direction of the autonomous vehicle using the parking lot map,
wherein the controller is configured to generate a second shortest turning path of the autonomous vehicle using a shortest turning path generating method that uses the reset turning start point of the autonomous vehicle, the reset turning start direction of the autonomous vehicle, the set turning end point of the autonomous vehicle, and the reset turning end direction of the autonomous vehicle as input information, and
wherein the controller is configured to operate the driving source to drive the autonomous vehicle along the second shortest turning path.

8. The device of claim 7, wherein a method for generating the second shortest turning path includes a Dubins path generation method that generates the second shortest turning path using the reset turning start point of the autonomous vehicle, the reset turning start direction of the autonomous vehicle, a circle that has a turning radius at the reset turning start point of the autonomous vehicle and prevents a rear end of the autonomous vehicle from hitting the first obstacle, the set turning end point of the autonomous vehicle, the reset turning end direction of the autonomous vehicle, and a circle that has a turning radius of less than or equal to a maximum turning radius of the autonomous vehicle at the set turning end point of the autonomous vehicle.
